(19) United States
(12) Patent Application Publication
(10) Pub. No.: US 2012/0271719 A1
(43) Pub. Date: Oct. 25, 2012

(54) TARGETING ADVERTISING BASED ON TRACKING CONTENT SHARING

(76) Inventors: Ben Straley, Seattle, WA (US); Bradley Young, Covington, WA (US); Ben Anderson, Seattle, WA (US); Filiberto Selvas, Redmond, WA (US)

(21) Appl. No.: 13/093,805

(22) Filed: Apr. 25, 2011

(51) Int. Cl. G06Q 30/00

(52) U.S. Cl. 705/14.66

(57) ABSTRACT

A facility for populating an advertising segment is described. For distinguished content, the facility accesses a data structure that, for each of two or more users, relates an instance of sharing of the distinguished content to the user with one or more instances of sharing the distinguished content from the user. The facility accesses a segment definition that specifies a test that, for each of the users, is either satisfied or not satisfied based upon the contents of the data structure. The facility selects the users for whom the test is satisfies, and constructs a list of identifiers identifying the selected users.

### CROSS-REFERENCE TO RELATED APPLICATIONS

This application is related to the following patent applications, each of which is hereby incorporated by reference in its entirety: U.S. Provisional Patent Application No. 61/052,596, filed May 12, 2008; U.S. Provisional Patent Application No. 61/111,639, filed Nov. 5, 2008; U.S. Provisional Patent Application No. 61/114,400, filed Nov. 13, 2008; and U.S. Provisional Patent Application No. 61/160,628, filed Mar. 16, 2009; and U.S. patent application Ser. No. 12/464,703, filed May 12, 2009.

### BACKGROUND

Online advertising involves the presentation of advertising messages to users, often on web pages. These advertising messages may take a variety of forms, including banner ads, text ads, video ads, slideshow ads, animation ads, etc. An advertiser typically pays the publisher of a web site containing a page, directly or indirectly, to cause an advertising message specified by the advertiser to be included in the page when viewed by a user.

Advertising targeting refers to selecting an advertising message to be included in a particular page viewed by a particular user at a particular time. A typical conventional approach to targeting involves inferring the user's interests based upon pages earlier viewed by the user, and selecting an advertising message that relates to one of these interests.

In particular, this conventional approach to targeting often uses the notion of “segments.” A definition is specified for a segment; the definition comprises a test against a user's earlier web-browsing behavior that, if satisfied, suggests that the user has a particular interest. For example, a “new car shoppers” segment may have a definition whose test is whether a user has at least twice in the past month visited a web page for configuring the options for a new car. Any users who satisfy this test are said to be members of the “new car shoppers” segment, and may be candidates to receive an advertising message from an automobile manufacturer advertiser about a new car model being introduced.

### BRIEF DESCRIPTION OF THE DRAWINGS

FIG. 1 is a high-level data flow diagram showing data flow within a typical arrangement of components used to provide the facility.

FIG. 2 is a block diagram showing some of the components typically incorporated in at least some of the computer systems and other devices on which the facility executes.

FIG. 3 is a flow diagram showing steps typically performed by the facility in order to track the sharing of a piece of content between a pair of users.

FIG. 4 is a data structure diagram showing sample initial contents of a content sharing tree data structure maintained by the facility.

FIG. 5 is a data structure diagram showing sample updated contents of the sharing tracking tree data structure shown in FIG. 5.

FIG. 6 is a display diagram showing a sample display presented by the facility in some embodiments in order to permit explicit sharing of content.

FIGS. 7A-7B are display diagrams showing sample displays typically presented by the facility in order to convey the results of its sharing analysis and conversion attribution.

FIG. 8 is a display diagram showing a sample display presented by the facility in some embodiments to illustrate sharing geographically.

FIG. 9 is a flow diagram showing steps typically performed by the facility in order to present advertising on the basis of content sharing.

FIG. 10 is a data structure diagram showing a sample content sharing graph that is the subject of sample advertising requests.

### DETAILED DESCRIPTION

The inventors have identified shortcomings in conventional approaches to targeting advertising. In particular, a user's viewing of a web page may not always reflect a significant interest in a subject that has been attributed to the web page. For example, the user may have navigated to the web page idly, with little interest; by mistake; or for a reason that diverges from the subject that has been attributed to the web page.

To overcome these shortcomings of conventional approaches to targeting advertising, the inventors have identified an approach that targets advertising relative to content sharing. The advertising targeting technique described herein builds on a technique for tracking the implicit trajectory of URL sharing, and offers a way to attribute individual conversions to those sharing trajectories. It allows site owners to answer the question, “To what extent is my online revenue due to sharing, and which sharing actions, channels, or web sites were catalysts for that sharing?”

The Internet is filled with web sites for sharing URLs to “interesting” content. Many people spend considerable time finding interesting content and then passing it on to friends via email, instant messenger and dedicated link sharing sites (like reddit.com and digg.com). A common example would be a video shared on youtube.com.

Have you seen this? http://www.youtube.com/watch?v=oiHCR19Ckkw

A software and/or hardware facility for targeting advertising based on tracking content sharing (“the facility”) is described. In various embodiments, the facility tracks various types of content, including web pages or portions of web pages, such as widgets. A widget is a largely self-contained portion of a web page, in some cases added to a web page by adding to the source for the web page an inclusion reference that points to code and/or content for the widget. For example, some video sharing services permit a widget containing a player for playing a particular video sequence hosted by the video sharing service to be added to any web page by adding to the source for the web page an inclusion reference pointing to the video sequence.

In some embodiments, the facility tracks the sharing of content that is accomplished by providing a reference to the content—such as a URL pointing to the content—to another user. For example, the shared URL or other reference may point to a web page, a widget, an image, an Adobe Flash show, etc. that a sharing source user wishes to share with a sharing target user. The sharing source user may select any of a large number of communication modalities to communicate the reference to another user, such as email; instant messaging; a blog, social networking site user page, or other web page; a bookmark sharing service; or even voice or handwriting. This form of sharing is sometimes referred to as sharing by reference.

In some embodiments, the facility tracks the sharing of content by reference by embedding into a reference to content a sharing source identifier that identifies the user most recently observed to possess a this version of the reference. When a user accesses content by dereferencing a reference containing a sharing source identifier, such as by instructing a browser to load and display content referred to by a URL, the facility determines whether the sharing source identifier matches an identifier identifying the accessing user. If these identifiers do not match, the facility (a) generates an indication that the user identified by the sharing source identifier shared the content identified by the invariant part of the URL (that is, the part of the URL that is not the sharing source identifier) with the accessing user, and (b) modifies the reference to change the sharing source identifier it contains to match the identifier identifying the accessing user.

In some embodiments, steps (a) and (b) described above are performed at least in part by script code or other code executed by the browser on the computer system being used by the sharing target user. In some embodiments, these steps are performed wholly by one or more servers that are distinct from the computer system being used by the sharing target user, sometimes referred to as tracking servers. A tracking server can be incorporated into a content server serving the shared content, or can alternatively be implemented separately from the content server.

In some embodiments, generating the sharing indication specifying the sharing source identifier and the identifier of the accessing user—also referred to as the sharing target identifier—involves augmenting a sharing graph in which a new node representing the sharing target identifier is created as a child of an existing node representing the sharing source identifier. In some embodiments, users in various categories of users are able to access and display some or all of the sharing tree maintained in this manner by the facility.

In some embodiments, the facility (or a separate mechanism) tracks conversions by users in terms of the same user identifiers used to track content sharing. This enables the facility to identify, for each conversion, any sequences of users who shared content to the converting user that relates to the conversion, either because the content was shared to the converting user shortly in advance of the conversion, the nature of the shared content relates specifically to the nature of the conversion, or both. In some embodiments, the facility adds information about such track conversions to the sharing graph generated by the facility.

In some embodiments, the facility permits an advertising segment to be defined based upon an arbitrary query against the sharing graph for one or more pieces of content. For example, a “new auto model enthusiast” segment may be defined based upon a sharing graph in which the facility tracks the sharing of a web page containing an auto manufacturer's announcement of a new car model. In this example, the segment definition defines the segment as any user that the graph shows has shared this web page with at least three other users. Alternatively, the segment could be defined to include in the segment any user whose sharing of the web page resulted either directly or indirectly in at least one conversion event by another user. Based upon such a definition, the facility applies the query specified by the segment definition to the sharing graphs for one or more appropriate pieces of content to obtain a list of users who are in the segment. This is sometimes referred to as “populating” the segment. The facility then makes these users within the segment's population candidates for receiving an advertising message appropriate to the segment's identity, such as an advertising message about an opportunity to test-drive the new car model whose launch is described in the announcement. Thus, segments can be defined based upon tracked “multi-generational” sharing, where sharing by a node's descendants is considered.

In a variety of embodiments, the facility employs a variety of approaches to effect advertising in accordance with the segment. In some embodiments, the facility passes identifiers for the users in the segment to a third-party advertising company, such as a Demand Side Platform (“DSP”), which monitors for advertising opportunities arising for users having these identifiers in connection with the web pages for one or more publishers, and can cause the specified advertising message to be presented to them.

In some embodiments, the facility can independently track the sharing of two or more pieces of content included in the same web page, or in the same container of another type. For example, the facility may independently track multiple widgets included in the same page.

In some embodiments, rather than or in addition to tracking the sharing of content by reference, the facility tracks the sharing of content by value, in which the user shares the content by providing the data making up the content to the sharing target user. For example, the sharing source user may provide the data making up an image, an audio sequence, a computer game or other program, etc. In such cases, the facility typically embeds the sharing user identifier in the shared data, in some cases in addition to a content id. Tracking sharing by value typically also involves embedding tracking code in the shared data, or installing tracking code on the computer system on which the shared data is accessed.

In some embodiments, in addition to tracking the implicit sharing of content, the facility also tracks the explicit sharing of content, such as sharing that the sharing source user accomplishes by operating a special sharing mechanism made available to the sharing source user in connection with the content. In various embodiments, the facility tracks the explicit sharing of contents and/or displays the results of sharing tracking in some or all of the ways described in U.S. patent application Ser. No. 11/756,068, filed May 31, 2007, which is hereby incorporated by reference in its entirety.

By performing in some or all of these ways, the facility enables advertisers to present advertising message to a receptive group of advertising prospects.

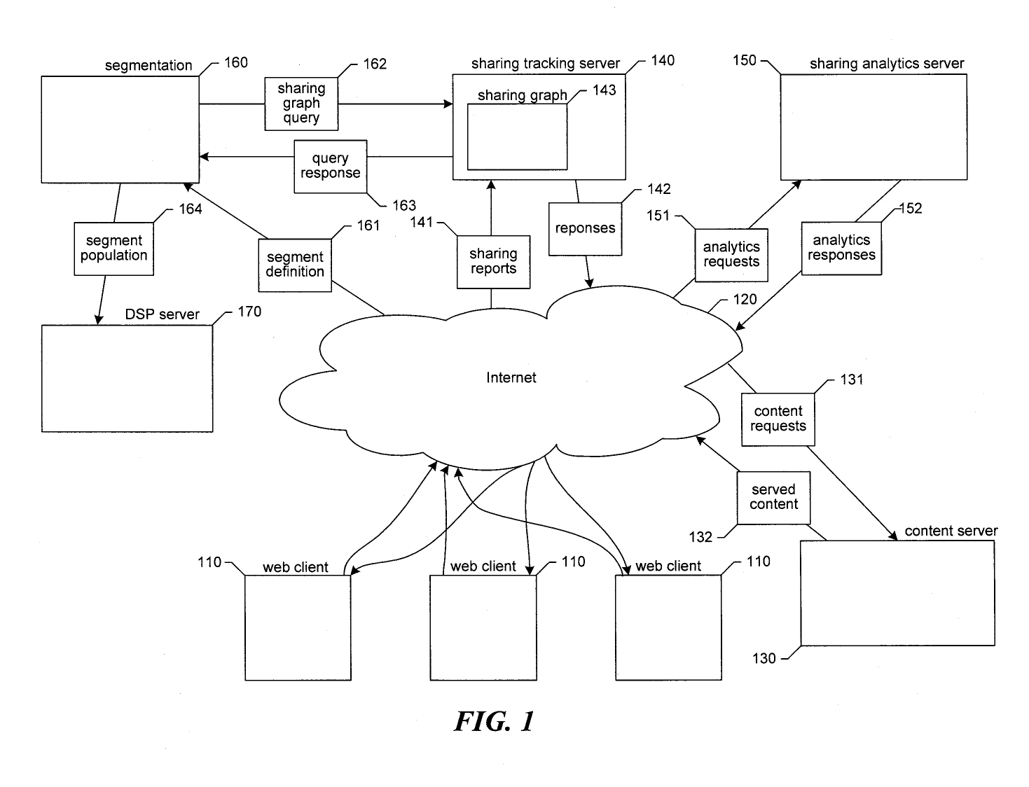

FIG. 1 is a high-level data flow diagram showing data flow within a typical arrangement of components used to provide the facility. A number of web client computer systems 110 that are under user control generate and send content requests 131 to a logical content server 130 via a network such as the Internet 120. These requests typically include page view requests or other kinds of requests for content. Typically, each content request specifies a reference for content to be returned, such as a URL. Users may use a variety of applications to provide content or references to content to other users to effect the sharing of content. Within the web server, these requests may either all be routed to a single content server computer system, or may be load-balanced among a number of content server computer systems. The content server typically replies to each with served content 132. In various embodiments, each web client that retrieves content whose sharing is being tracked also interacts with a sharing tracking server 140. The web client sends one or more sharing reports 141 to web tracking server 140, and typically receives a response 142 for each sharing request sent. In response to each sharing report it receives, the sharing tracking server updates a sharing graph 143 it maintains for the content being tracked to reflect the instance of sharing represented by the sharing report. In some embodiments, certain web clients communicate with a sharing analytics server 150. These clients send analytics requests 151 for particular sharing analytics information, and receive analytics responses 152 that are responsive to the requests. A segmentation server 160 operated by the facility receives a segment definition 161, such as from an advertiser, an advertiser's representative, or an employee of the operator of the facility. The segmentation server passes the sharing graph query 162 within the segment definition to the sharing tracking server, which applies the query against the sharing graph in its current state. The sharing tracking server returns to the segmentation server the query response 163 it obtains by applying the query, which lists any users whose nodes of the sharing graphs satisfy the query. The segmentation server then sends identifiers for this list of users as a segment population 164 to a DSP server 170 for its use in selecting advertising messages to be presented to particular users.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different client devices may be used in place of the web client computer systems, such as mobile phones, personal digital assistants, televisions, digital video recorders, set top boxes, cameras, automobile computers, etc. In various embodiments, the client devices include one or more of the following: iPhone, iPad, iTouch, Adroid based Mobile Phones, Android Based Tables, Windows Based Tablets, Symbian based Mobile Phones, Symbian Based Mobile Phones, Symbian based Tablets, Blackberry OS based mobile phones, Blackberry OS based Tablets, and Web enabled TVs.

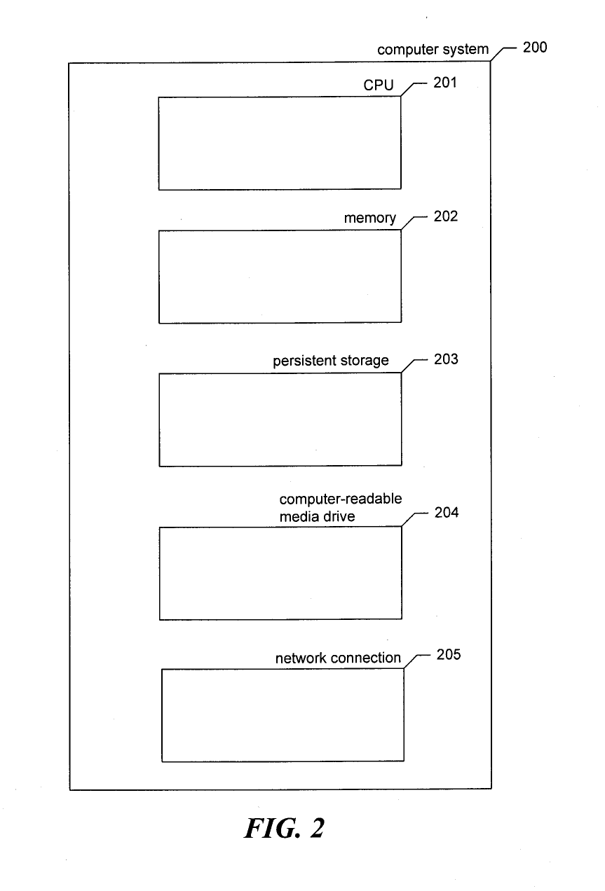

FIG. 2 is a block diagram showing some of the components typically incorporated in at least some of the computer systems and other devices on which the facility executes. These computer systems and devices 200 may include one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable medium; and a network connection 205 for connecting the computer system to other computer systems, such as via the Internet or one or more other data transmission networks, so that data signals such as data signals conveying data structures may be sent between such computer systems. While computer systems configured as described above are typically used to support the operation of the facility, those skilled in the art will appreciate that the facility may be implemented using devices of various types and configurations, and having various components.

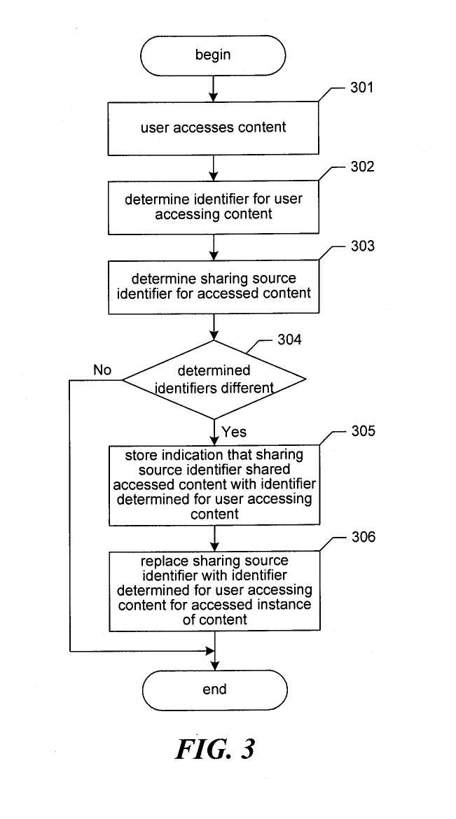

FIG. 3 is a flow diagram showing steps typically performed by the facility in order to track the sharing of a piece of content between a pair of users. The user who shared the content is referred to herein with respect to this particular instance of sharing as the sharing source user. The user to whom the piece of content is shared is referred to herein with respect to this instance of sharing as the sharing target user. In step 301, the user accesses a particular piece of content. In various embodiments, this content accessing takes a variety of forms. In some embodiments, the user accesses the piece of content in step 301 by dispatching a request identifying the content, such as an HTTP request identifying a URL specifying the content, to a content server, such as by using a web browser application executing on a client computer system or other device used by the user. The accessed content is often displayed or otherwise presented to the accessing user.

In step 302, the facility determines an identifier for the user accessing the content. This identifier is typically determined with reference to the client computer system. An identifier for the user may be stored in one or more of a variety of forms such as any of the following: http cookies, third-party cookies, DOM storage, Internet Explorer userData, flash local shared objects, IP address, MAC address, user log-in, serial number for some device on the user's computer system such as processor serial number, etc. If the facility determines that the user accessing the content has not yet been attributed an identifier, the facility typically attributes an unused identifier to the accessing user, such as with reference to the sharing tracking server. In step 303, the facility determines a sharing source identifier for the accessed content. Where content is shared by reference, the sharing source identifier is typically stored in the reference to the content that is forwarded from the sharing source user to the sharing target user and used by the sharing target user to access the content. The sample URLs in the table below show examples of how the sharing source identifier, shown as “<identifier>”, may be incorporated in references that are URLs.

TABLE 1
in URL Segments: http://www.samplesite.com/sample_page/<identifier>/
in Query String: http://www.samplesite.com/sample_page?some_key
=<identifier>
in Hash: http://www.samplesite.com/sample_page#<identifier>
in Sub Domain: http://<identifier>.samplesite.com/sample_page

In some embodiments, the facility encodes both the sharing source identifier and information identifying the shared content in the URL in an indivisible way. For example, the URL “http://www.samplesite.com/54137618” may encode the sharing source identifier 9738 and the content identifier 76, while the URL “http://www.samplesite.com/98148271” may encode the sharing source identifier 2301 and the content identifier 76. In such embodiments, a mapping is maintained from each URL or URL segment to a corresponding sharing source identifier+content identifier tuple. Such embodiments may be implemented in connection with a “URL shortening service,” such as bit.ly, tinyurl.com, is.gd, eKey.us, Cli.gs, or SnipURL.

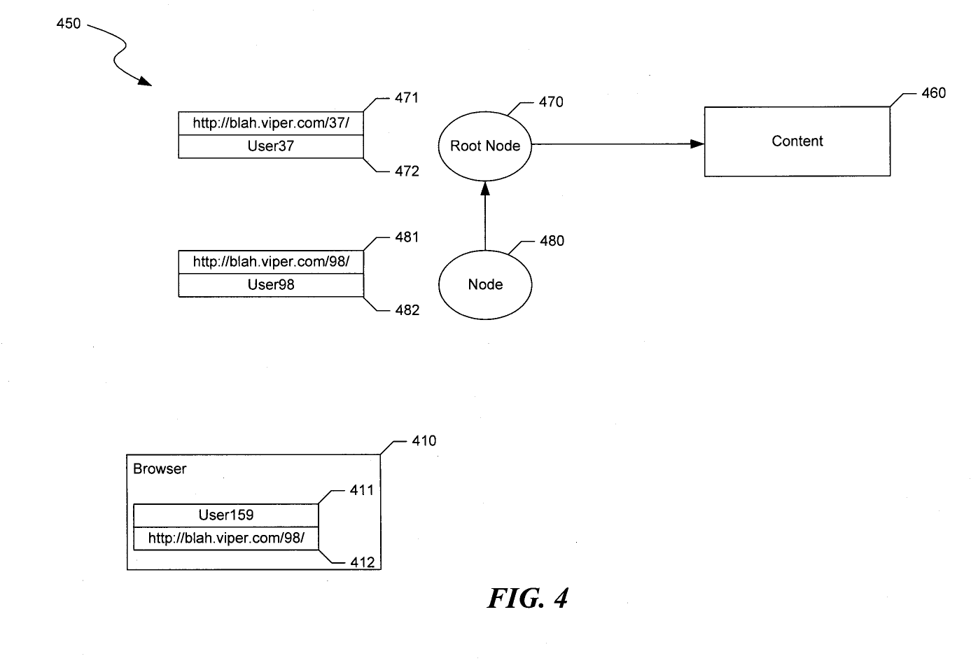

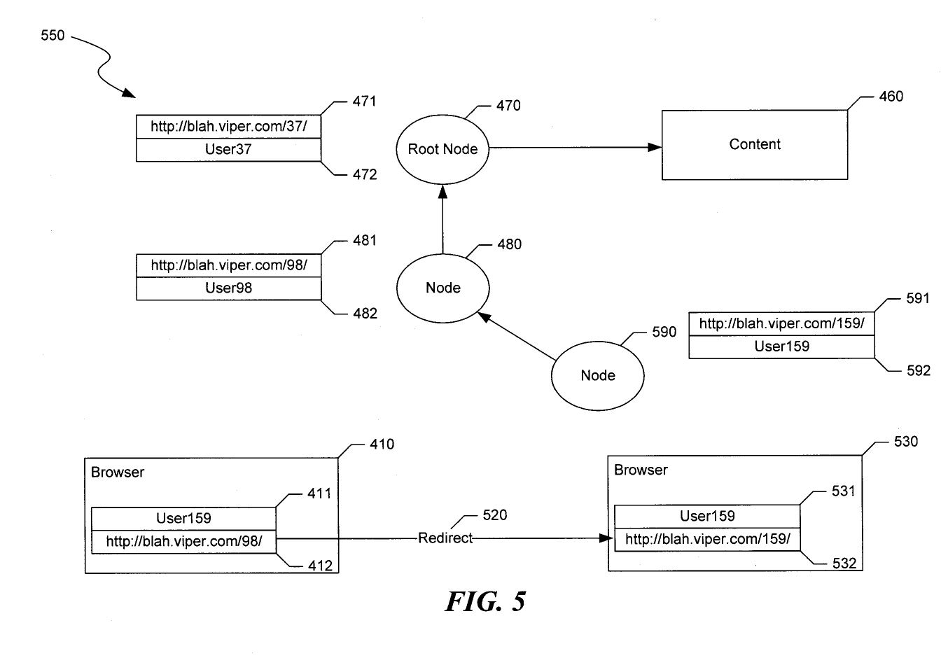

In step 304, if the identifiers determined in steps 302 and 303 are different, then the facility continues in step 305, else the steps conclude. In step 305, the facility stores an indication that the sharing source identifier shared the accessed content with the identifier determined for the user accessing the content. In some embodiments, this involves augmenting a sharing tree maintained for the accessed content, as is described in more detail below in connection with FIGS. 4 and 5.

FIG. 4 is a data structure diagram showing sample initial contents of a content sharing tree data structure maintained by the facility. This data structure is typically stored by a computer system, such as in volatile and/or persistent memory, and reflects the state of the data structure after a user has accessed content in step 301, but before the facility stores an indication in step 305. The tree has a root node 470, which identifies the piece of content 460 whose sharing is tracked by the tree. Attached to the root node 470 is a URL 471 that identifies both the content 460 (“http://blah.viper.com”) as well as the user responsible for generating a content or making the content available (“/37/”). Also attached to the root node is an indication 472 of the identity of this user. Node 480 is a child node of root node 470, indicating that it corresponds to the sharing of the content 460 from user 37 to another user. In particular, the URL 481 and indication 482 of the sharing target ID show that this node corresponds to the sharing of content 460 from user 37 to user 98. Action record 410 shows that user 159 has just retrieved content 460 using URL 412, which contains the sharing source identifier 37.

While FIG. 4 and each of the data structure diagrams discussed below show a data structure whose contents and organization are designed to make them more comprehensible by a human reader, those skilled in the art will appreciate that actual data structures used by the facility to store this information may differ from the data structure shown, in that they, for example, may be organized in a different manner; may contain more or less information than shown; may be compressed and/or encrypted; etc.

FIG. 5 is a data structure diagram showing sample updated contents of the sharing tracking tree data structure shown in FIG. 5. The sharing tracking tree data structure has been augmented to reflect the new instance of sharing shown in action record 410. In particular, the facility has added a new node 590 as a child of node 480, indicating that new node 590 represents the sharing of content 460 from user 98 to user 159.

Returning to FIG. 3, in step 306, the facility replaces the sharing source identifier with the identifier determined for the user accessing the content for the accessed instance of content. In some embodiments, the facility performs step 306 by redirecting the accessing user's browser to a version of the URL in which the sharing source identifier has been replaced with the identifier determined for the accessing user. This may be accomplished in a variety of ways, including causing the content server to perform the redirect in response to the initial request for content, on consultation with the sharing tracking server; changing the URL via code running on the client computer, such as Java, Javascript, Flash, or Silverlight code; issuing a command via a header from the server typically using the Location header; or issuing a command in HTML or another tag language such as <meta http-equiv=“refresh” content=“0; url=http://sample.com/new_id/”>.

Returning to FIG. 5, record 530 shows the replacement in the URL of the sharing source identifier 98 with the identifier determined for the accessing user 159.

Referring to FIG. 3, after step 306, these steps conclude. Those skilled in the art will appreciate that the steps shown in FIG. 3 and in each of the flow diagrams discussed below may be altered in a variety of ways. For example, the order of the steps may be rearranged; some steps may be performed in parallel; shown steps may be omitted, or other steps may be included; etc.

In a server-based approach to tracking, the interaction is all between the viewing machine and the content server. Some of the operations of the Content Server may be assisted by the Tracking Server, such as to generate Ids and record information. The server-based approach to tracking proceeds as shown below in Table 2.

TABLE 2

| | |
|---|---|
| 1. | User accesses content by opening a URL |
| 2. | Content Server checks the URL for an ID |
| 3. | If there an ID in URL, go to step 7 |
| 4. | Content Server checks for an ID from the computer system that is accessing |

the content

| | |
|---|---|
| 5. | If there is no ID from the computer system that is accessing the content |

| | |
|---|---|
| a. | Generate an ID; store it persistently on computer system on which |

content is being accessed and in URL

| | |
|---|---|
| b. | Record this as new user |
| c. | stop |

| | |
|---|---|
| 6. | If there is an ID in permanent storage |

| | |
|---|---|
| a. | Set the URL ID to the permanent ID |
| b. | Record this as “user with ID opening no ID URL” |
| c. | stop |

| | |
|---|---|
| 7. | (this user has a URL ID) now get the ID from the computer system that is |

accessing the content

| | |
|---|---|
| 8. | If there is no ID from the computer system that is accessing the content |

| | |
|---|---|
| a. | Generate a new ID |
| b. | Record this as sharing from an old user to this new ID |
| c. | Store it persistently on computer system on which content is being |

accessed and in URL

| | |
|---|---|
| d. | stop |

| | |
|---|---|
| 9. | If there is an ID from the computer system that is accessing the content and |

it matches the ID from the URL

| | |
|---|---|
| a. | Record this as the matching ID reopening the URL |
| b. | stop |

| | |
|---|---|
| 10. | If there is an ID from the computer system that is accessing the content and |

they don't match

| | |
|---|---|
| a. | Record this as the ID from the computer system that is accessing the |

content opening the URL ID - showing from user having ID from URL storage to user
having ID from permanent storage

| | |
|---|---|
| b. | Set the URL ID to ID from the computer system that is accessing the |

content

| | |
|---|---|
| c. | stop |

In a scripting based, synchronous approach to tracking, the control logic runs on the tracking server and the client has logic for following the tracking server's commands.

The process performed on the computer system accessing the content is as shown below in Table 3.

TABLE 3

| | |
|---|---|
| 1. | Client machine opens a URL |
| 2. | Content Server provides a script directly or points to a script |

on a third party machine

| | |
|---|---|
| 3. | Based on the script, the client machine takes the following set of |

actions:

| | |
|---|---|
| a. | Checks to see if the machine is capable of storing |

information in some form of permanent storage, if not it halts

| | |
|---|---|
| b. | Queries the tracking server with the permanent ID and the |

URL ID

| | |
|---|---|
| c. | Based on the command of the tracking server, may set |

permanent ID or URL ID values

The process performed by the tracking server for the scripting based, synchronous approach to tracking is as shown below in Table 4.

TABLE 4

| | |
|---|---|
| 1. | Inspects the URL ID and the permanent ID |
| 2. | If they are both set and they match: |

| | |
|---|---|
| a. | Record this as that ID reopening the URL. |
| b. | Instruct the Viewing Machine to do nothing. |

| | |
|---|---|
| 3. | If they are both set and they do no match: |

| | |
|---|---|
| a. | Record this as the permanent ID opening the |

URL ID.

| | |
|---|---|
| b. | Instruct the Viewing Machine to set the URL ID to |

match the permanent ID.

| | |
|---|---|
| 4. | If the permanent ID is set, but the URL ID is not set |

| | |
|---|---|
| a. | Record this as the permanent ID opening a blank ID. |
| b. | Instruct the Viewing Machine to set the URL ID to |

match the storage ID.

| | |
|---|---|
| 5. | If the URL ID is set but the permanent ID is not set: |

| | |
|---|---|
| a. | Record this as a new user opening content shared |

from the permanent ID.

| | |
|---|---|
| b. | Generate a new ID |
| c. | Instruct the Viewing Machine to set that new ID as |

permanent and URL ID.

In a scripting based, asynchronous approach to tracking, all of the logic runs on the client; the tracking server just receives and records information from the client. The Asynchronous approach differs from the Synchronous approach described above in that, in the Asynchronous approach, the Viewing Machine does not need to wait on the tracking machine once it has fetched its script. The scripting based, asynchronous approach to tracking proceeds as shown below in Table 5.

TABLE 5

| | |
|---|---|
| 1. | Client Machine opens a URL. |
| 2. | Client Machine (either has built-in) or loads a script from a server. |
| 3. | Based on the Client Side Script, the client machine takes the following set of |

actions:

| | |
|---|---|
| 4. | If the client is not capable of storing information in permanent storage, then |

halt.

| | |
|---|---|
| 5. | Client machine looks at URL ID and an ID from the computer system that is |

accessing the content

| | |
|---|---|
| 6. | If the two IDs are not identical: |

| | |
|---|---|
| a. | If there is no ID from the computer system that is accessing the |

content, but there is a URL ID:

| | |
|---|---|
| 1. | On the client, generate a new ID |
| 2. | Create and store a pending notification that the content was |

shared from the URL ID to the generated ID

| | |
|---|---|
| 3. | Set URL ID to the generated ID |
| 4. | Report pending notifications to the Tracking Server |

| | |
|---|---|
| b. | If there is an ID from the computer system that is accessing the |

content, but it does match the URL ID:

| | |
|---|---|
| 1. | Create a pending notification that the content was shared from |

the URL ID to the ID from the computer system that is accessing the content

| | |
|---|---|
| 2. | Set URL ID to the ID from the computer system that is |

accessing the content

| | |
|---|---|
| 3. | Report pending notifications to the Tracking Server |

| | |
|---|---|
| c. | If there is an ID from the computer system that is accessing the |

content, but no URL ID

| | |
|---|---|
| 1. | Create a pending notification that the URL ID opened a piece |

of content with no ID

| | |
|---|---|
| 2. | Set the URL ID to the ID from the computer system that is |

accessing the content

| | |
|---|---|
| 3. | Report pending notifications to the Tracking Server |

| | |
|---|---|
| 7. | If they both are present and match: |

| | |
|---|---|
| a. | Check Persistent Storage on the Client Machine for pending |

notifications, if there are any send them to the Tracking Server then done.

| | |
|---|---|
| b. | If there are no pending notifications, report this to the Tracking Server |

as the ID being reopened

| | |
|---|---|
| 8. | Done |

In some embodiments, the facility tracks the sharing of widgets. A widget is content that can be embedded inside a web page and easily shared by users allowing them to easily add it to their own web pages. For example, a YouTube video sequence that can be added to a user's web page is one form of widget.

The facility tracks the sharing of widgets via two paths: page sharing (when users share a URL for a web page that has widget content) and widget sharing (when a user copies a widget and adds it to his or her own web page).

When a user initially traverses to any given page containing a widget, the page will have two unique identifiers: one is stored in the widget and the other is stored in the URL.

The process by which the facility tracks the sharing of widgets is shown below in Table 6.

TABLE 6

| | |
|---|---|
| 1. | User opens page with a widget and its tracking codes |
| 2. | For each widget with tracking code, find the 2 identifiers on this page: (URL |

identifier & Widget Identifier)

| | |
|---|---|
| 3. | Get this user's identifier or generate a new one: ideally this would be |

consistent across all sites (such as flash storage or a 3^{rd} party cookie)

| | |
|---|---|
| 4. | Report these three identifiers, along with the complete URL and referrer |

information to the Tracking Server.

| | |
|---|---|
| 5. | If the identifier set in the URL is different then this user's identifier, change it |

to match this users identifier.

| | |
|---|---|
| 6. | If the user embeds this widget into another page, make that widget identifier |

match this users identifier, typically by changing the embed code.

Table 7 below shows original Javascript code for incorporating a video sequence widget into a web page.

TABLE 7
<object width=“480” height=“295”><param name=“movie”
value=“http://www.youtube.com/v/5mvtU4xZPvQ&hl=en&fs=1”></param><param
name=“allowFullScreen” value=“true”></param><param name=“allowscriptaccess”
value=“always”></param><embed src=“http://www.youtube.com/v/5mvtU4xZPvQ&hl=en&fs=1”
type=“application/x-shockwave-flash” allowscriptaccess=“always”
allowfullscreen=“true” width=“480” height=“295”></embed></object>

Table 8 below shows a manner in which the code for incorporating a widget can be encoded in order to support tracking of the sharing of the widget.

TABLE 8
<script type=“text/javascript”
src=“http://static.meteorsolutions.com/meteor.js”></script><script
type=“text/javascript”>meteor.widget_tracker.get(“1”,“2”).set({“html”:“%3Cobject%20width%3D%22480%22
%20height%3D%22295%22%3E%3Cparam%20name%3D%22movie%22%20value%3D%22http%3A//www.youtube.com/v/5mvtU4
xZPvQ%26hl%3Den%26fs%3D1%22%3E%3C/param%3E%3Cparam%20name%3D%22allowFullScreen%22%20value%3D%22true%
22%3E%3C/param%3E%3Cparam%20name%3D%22allowscriptaccess%22%20value%3D%22always%22%3E%3C/param%3E%3Cembed
%20src%3D%22http%3A//www.youtube.com/v/5mvtU4xZPvQ%26hl%3Den%26fs%3D1%22%20type%3D%22application
/x-shockwave-
flash%22%20allowscriptaccess%3D%22always%22%20allowfullscreen%3D%22true%22%20width%3D%22480%22%20height
%3D%22295%22%3E%3C/embed%3E%3C/object%3E”,“embed_code_from_id”:“91358671”}).track( ).write( );</script>

The “1” string identifies a customer that is tracking the sharing of the widget, while the “2” string identifies a widget. The “91358671” string identifies the user who was the source of the current instance of the widget.

Table 9 below shows sample Javascript included in a tracked page containing a widget to conduct the client process discussed above.

TABLE 9
// Widget Tracker
//
// for tracking widgets
meteor.add_to({ widget_tracker : {

trackers : [ ],
from_id : false,
to_id : false,
hash_prefix : ‘#meteor_widget:’,
// calculates what from id is set (if any)
build_from_id : function( )
{

var widget_tracker = meteor.widget_tracker;
meteor.once.run(‘widget_tracker_from_id’, function( ) {

var hash = document.location.hash;
if (hash.indexOf(widget_tracker.hash_prefix) == 0) {

widget_tracker.from_id =

hash.substring(widget_tracker.hash_prefix.length);

}

});
return widget_tracker.from_id;

},
set_to_id : function( )
{

var widget_tracker = meteor.widget_tracker;
meteor.once.run(‘widget_tracker_to_id’, function( ) {

// if the hash is valid (or empty)
if ((widget_tracker.from_id !== false) ∥ (window.location.hash == “)) {

meteor.global_id.get(function(global_id) {

if (global_id != ”) {

window.location.hash =

meteor.widget_tracker.hash_prefix + global_id;

widget_tracker.to_id = global_id;

}
meteor.fence.alert(‘widget_tracker_to_id’);

});

}

});

},
report_data : function(preferences)
{

var widget_tracker = meteor.widget_tracker;
meteor.fence.wait(‘widget_tracker_to_id’, function( ) {

var data = { };
data.application_id = preferences.application_id;
data.widget_id = preferences.widget_id;
data.embed_code_from_id = preferences.embed_code_from_id;
data.from_id = widget_tracker.from_id;
data.to_id = widget_tracker.to_id;
data.referrer = document.referrer;
data.location = window.location;
meteor.json_query(meteor.construct_url(‘sharing’,

‘api/widget_tracker’), data);

});

},
internal_track : function(preferences)
{

var widget_tracker = meteor.widget_tracker;
widget_tracker.build_from_id( );
widget_tracker.set_to_id( );
widget_tracker.report_data(preferences);

},
internal_write : function(preferences)
{

document.write(unescape(preferences.html));
document.write(‘<div><a href=“#”

onclick=“meteor.widget_tracker.internal_show_embed_code(this, \” +
preferences.application_id + ‘\’, \“ + preferences.widget_id + ‘\’, \” +
preferences.embed_code_from_id + ‘\’, \“ + preferences.html + ‘\’); return false”>Get
Embed Code</a></div>’);

},
internal_show_embed_code : function(el, application_id, widget_id, html)
{

var tracker = meteor.widget_tracker.get(application_id, widget_id);
// show the embed code right away even if we don't have this
var embed_code_from_id = meteor.global_id.get_if_available( ) + “;

var prefs_string = meteor.json_encode({ ‘html’ : tracker.preferences.html,

‘embed_code_from_id’ : embed_code_from_id});

var embed = ‘<script type=“text\/javascript” src=“meteor-

uncompressed.js”><\/script>’;

```
  embed += ‘<script type=“text\/javascript”>meteor.widget_tracker.get(‘;
  embed += “”‘ + application_id + ’“,”;
  embed += “”‘ + widget_id + ’“”;
  embed += ’).set(‘ + prefs_string + ’).track( ).write( );</script>’;
  var parent = el.parentNode;
  parent.innerHTML = ‘<input type=“text” readonly=“” onclick=“this.select( )”
```

value=“Embed Code”/>’;

```
  var node = parent.firstChild;
  node.value = embed;
  node.select( );
},
get : function(application_id, widget_id) {
```

var widget_tracker = meteor.widget_tracker;
var tracker;
for (var index = 0; index < widget_tracker.trackers.length; index++) {

tracker = widget_tracker.trackers[index];
if ((application_id == tracker.application_id) && (widget_id ==

tracker.widget_id)) {

return tracker.tracker;

}

}
tracker = {

preferences : {

‘embed_code_from_id’ : “,
‘html’ : ”,
‘application_id’: application_id + “,
‘widget_id’ : widget_id + ”,

},
track : function ( ) {

widget_tracker.internal_track(tracker.preferences);
return tracker;

},
set : function(preferences)
{

for (var key in preferences) {

tracker.preferences[key] = preferences[key];

}
return tracker;

},
write : function(html) {

widget_tracker.internal_write(tracker.preferences, html);

}

};
widget_tracker.trackers.push({ ‘application_id’ : application_id, ‘widget_id’ :

widget_id, ‘tracker’ : tracker});

return tracker;

}

}});
// step 1 : find the from ID and store it (empty or not)
// step 2 : the first widget that tracks, set the ID (if allowed, we won't override a hash that is
present)
// step 3 : each widget that calls track report the analytics data

Table 10 below shows how the encoded version of the widget in Table 8 is modified to reflect its sharing from the user having user ID “91358671” to user having user ID “22315410”.

TABLE 10
<script type=“text/javascript”
src=“http://static.meteorsolutions.com/meteor.js”></script><script
type=“text/javascript”>meteor.widget_tracker.get(“1”,“2”).set({“html”:“%3Cobject%20width%3D%22480%22
%20height%3D%22295%22%3E%3Cparam%20name%3D%22movie%22%20value%3D%22http%3A//www.youtube.com/v/5mvtU4
xZPvQ%26hl%3Den%26fs%3D1%22%3E%3C/param%3E%3Cparam%20name%3D%22allowFullScreen%22%20value%3D%22true%
22%3E%3C/param%3E%3Cparam%20name%3D%22allowscriptaccess%22%20value%3D%22always%22%3E%3C/param%3E%3Cembed
%20src%3D%22http%3A//www.youtube.com/v/5mvtU4xZPvQ%26hl%3Den%26fs%3D1%22%20type%3D%22application
/x-shockwave-
flash%22%20allowscriptaccess%3D%22always%22%20allowfullscreen%3D%22true%22%20width%3D%22480%22%20height
%3D%22295%22%3E%3C/embed%3E%3C/object%3E”,“embed_code_from_id”:“22315410”}).track( ).write( );</script>

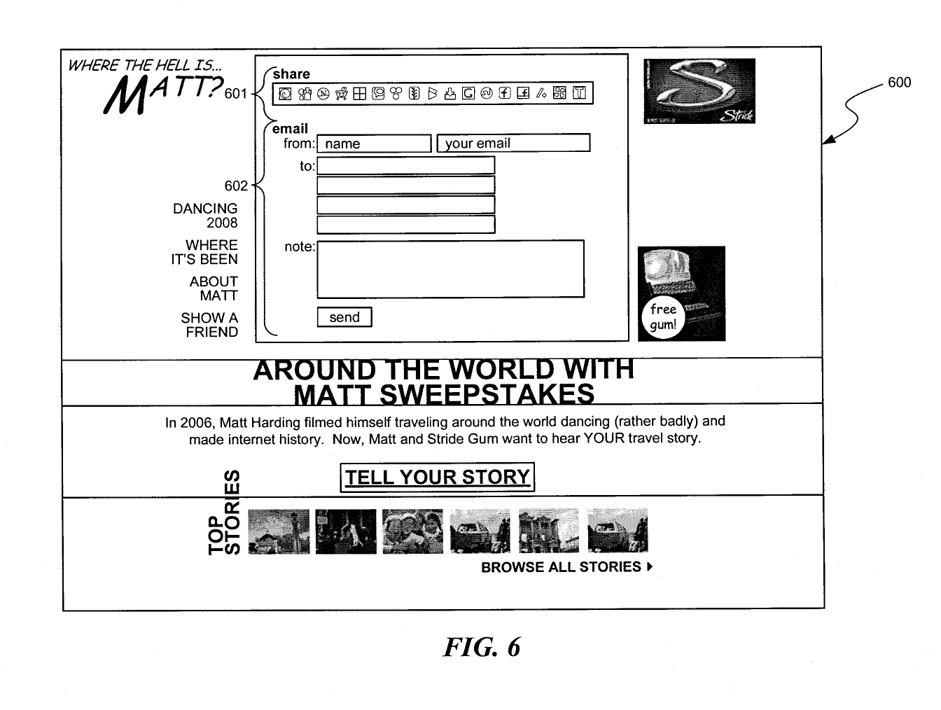

In some embodiments, the facility tracks explicit sharing along with implicit sharing. In some embodiments, the facility provides explicit sharing functionality that a user may use in order to share functionality for explicitly sharing content in connection with content. For example, FIG. 6 is a display diagram showing a sample display presented by the facility in some embodiments in order to permit explicit sharing of content. The display 600 includes certain content about a world travel adventure. The display also includes a number of icons 601 for popular content sharing sites that the user may select in order to share the content via the selected site. Alternatively, the user may use email section 602 to generate and send an email message sharing the content to one or more other users. In such embodiments, the facility typically creates a new node for each recipient to whom the piece of content is explicitly shared, so that the creation of this node and any descendent nodes is not conditioned upon the recipient accessing the content in a detectable way. In some embodiments, this functionality includes mechanisms for maintaining and using a list of frequently shared-with users. Also, the functionality can be tied to accounts maintained by the user on multiple sharing sites to further automate sharing via these sharing sites.

In some embodiments, the facility tracks conversions, which it then relates to sharing of content. In order to take advantage of such conversion tracking and attribution, the operator of the web site causes client-side tracking code to be called whenever a conversion occurs on their web site. In some embodiments, the call to the client-side tracking code identifies a type of conversion that was performed to get to the current page, or a particular value for the conversion.

To track a typical conversion within this system, the facility performs the process shown in Table 11 below.

TABLE 11

| | |
|---|---|
| 1. | An end-user visits a page whose content has its sharing trajectory tracked. |
| 2. | The end-user is assigned a URL ID, which is kept in the persistent storage of |

his or her browser. The user may have arrived at the page as a result of sharing, in which
case he or she will also have a parent URL ID stored in the sharing trajectory graph.

| | |
|---|---|
| 3. | The end-user continues to browse and at some point converts as defined by |

the site owner by placing the client-side tracking code in the page representing
conversion.

| | |
|---|---|
| 4. | The client-side tracking code is run; it generates an HTTP request to the |

application server containing the end-user's URL ID, the URL of the current page, the
HTTP referrer of the current page, and the URL of the entry point.

| | |
|---|---|
| 5. | The server, receiving the request from the client's browser, consults the |

sharing trajectory associated with the client's URL ID. If the URL ID has a parent, the
conversion has resulted from sharing; if it has no parent, the conversion has not resulted
from sharing. This fact, along with the other data sent by the client's browser, is stored in
a database.

In some embodiments, the facility includes tools to analyze the data to derive meaningful and important information about the conversions that occur on a site. The following information can be determined from the data gathered above as shown below in Table 12.

TABLE 12

| | |
|---|---|
| 1. | The conversion rate from sharing can be defined as the ratio of conversions |

with a parent Node ID to the number of Node IDs with parents for a given site.

| | |
|---|---|
| 2. | The conversion rate among visits not resulting from sharing can be defined |

as the ratio of conversions without a parent Node ID to the number of Node IDs without
parents for the same site.

| | |
|---|---|
| 3. | Since conversions are attributed to nodes in a sharing trajectory graph, the |

conversions attributed to each node can be aggregated to that node's parent. This gives
us for each node the number of conversions which resulted indirectly from sharing starting
at that node, as well as the conversion rate among visits which resulted indirectly from
sharing.

| | |
|---|---|
| 4. | Since the site owner can generate seed nodes for expected sources of traffic |

(e.g. a display advertising campaign; this is a feature of the sharing trajectory graph) the
conversion rates for such sources of traffic can be compared with the conversion rate from
sharing.

| | |
|---|---|
| 5. | If the site owner can place a dollar value on the conversions detected at a |

given URL, the system can compute the revenue generated for the site owner as a result
of sharing, allowing the site owner to make judgments about the return on investment of
his or her activities to encourage sharing.

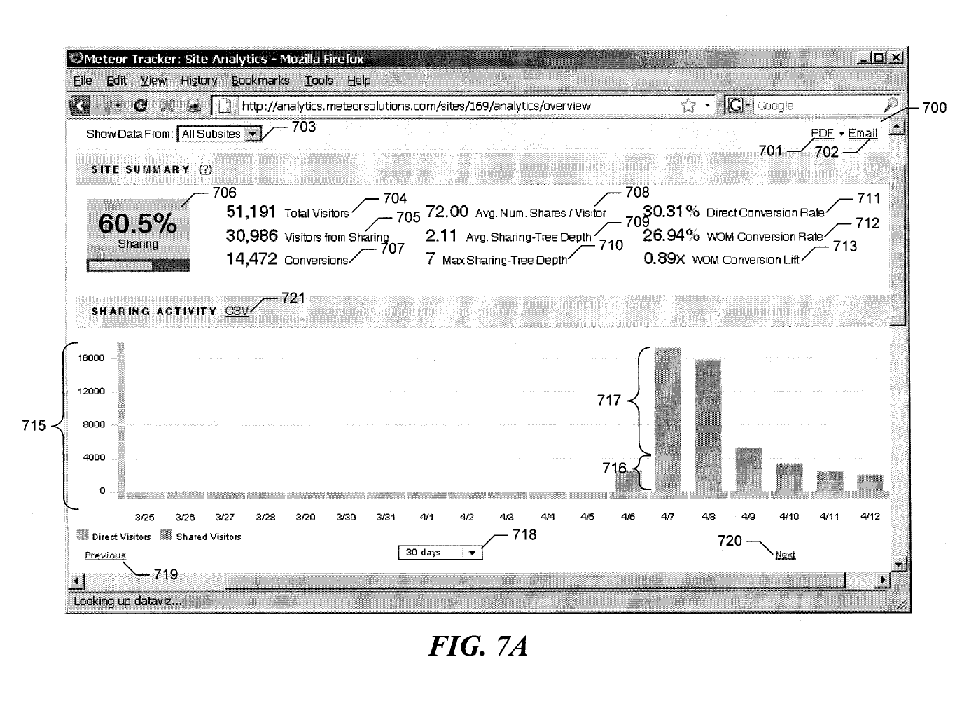

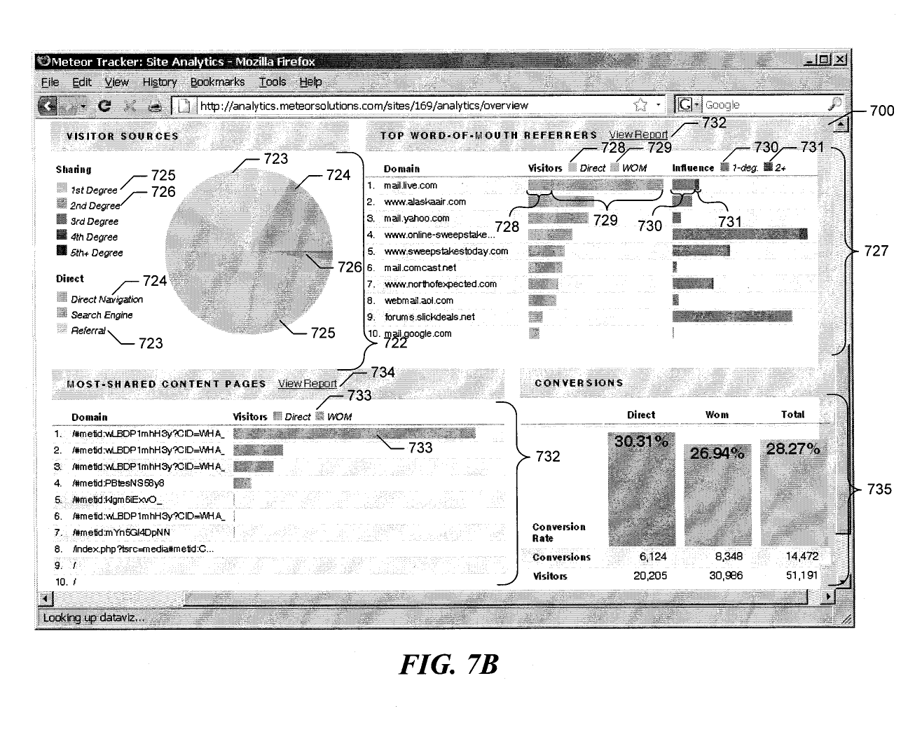

In some embodiments, the facility provides user interfaces for conveying one or more types of data generated by the facility. FIGS. 7A-7B are display diagrams showing sample displays typically presented by the facility in order to convey the results of its sharing analysis and conversion attribution. The display 700 includes controls 701 and 702 to generate a PDF file and an email, respectively, with the same contents as display 700, or a comma-delisted list (not shown). The display further includes a control 703 that can be used to select between displaying data relating to the publisher's entire web site and data relating to individual subsites within the publisher's web site. The display includes overall summary statistics 704-713 as follows: Indication 704 shows the total number of visitors to pages of the publisher's site that the publisher has selected for tracking. Indication 705 shows the number of these visitors that visited a page of the publisher's site in response to the sharing of content with them. Indication 706 shows the percentage of total visitors that visited as the result of sharing. Indication 707 shows the number of conversions that were performed among total visitors 704. Indication 708 shows, among the users who shared content, the average number of visitors from sharing produced by each such user sharing content. Indication 709 shows the average length of a sharing chain from the first user who shared content at the beginning of the chain to the last user to whom content was shared at the end of the chain. Indication 710 shows the length of the longest such sharing chain. Indication 711 shows the rate at which users who visited the site directly converted. Indication 712 shows the rate at which users who visited the site as the result of sharing converted. Indication 713 shows the ratio of indication 712 to indication 711.

The display further includes a bar graph 715 showing, for each day in a period of time, the number of direct visitors to the subject web site and the number of visitors to the subject web site that resulted from sharing. For example, on the date April 7, the bar graph shows that slightly more than 4,000 users visited the web site directly, while over 12,000 users visited the web site as the result of sharing. The display also includes control 718 for specifying the number of days' data showing one time in the bar chart, and controls 719 and 720 for navigating forward and backward in time for the bar chart.

Turning to FIG. 7B, the display further includes a pie chart 722 (or bar chart, not shown) of all of the sources of visitors for the subject web site. The pie chart includes segments for users who visited the web site as a result of a referral 723; users who visited the web site as the result of direct navigation 724; users who visited the web site as the result of first degree sharing 725 (i.e., users who were at the end of a two-user sharing chain); and users who visited as the result of second degree sharing 726.

The display further includes a bar chart 727 showing, for different referrer domains, the impact that the referrer domain has on the subject web site. The bar chart includes, for each referrer domain, the number of users who directly navigated from the referrer web site to the subject web site; the number of users who visited the subject web site from the referrer web site as the result of sharing 729; and the total number of visits produced by users from the referrer web site sharing with other users, both in sharing chains that are two users long 730 and sharing chains that are three or more users long 731. The display further includes a control 732 that the user may use in order to generate a more detailed version of bar chart 727.

The display further includes a bar chart 732 showing, among the pages of the subject web site that are selected for tracking, the number of direct and word of mouth users who visited each of these pages. The display also includes a control 734 that the user may select in order to view a more detailed version of this bar chart.

The display further includes a bar chart 735 showing, for direct visits, word of mouth visits, and total visits: the number of conversions, the number of visitors, and the conversion rate that results from dividing the former by the latter.

In some embodiments, the facility geographically maps the trajectory of content using existing techniques to resolve approximate geographic locations for shared-from and shared-to users from those users' IP addresses. The geographic mapping is a map on which the geographic locations determined for users with whom the content was shared are shown to be connected with the geographic locations determined for the users who shared the content with them.

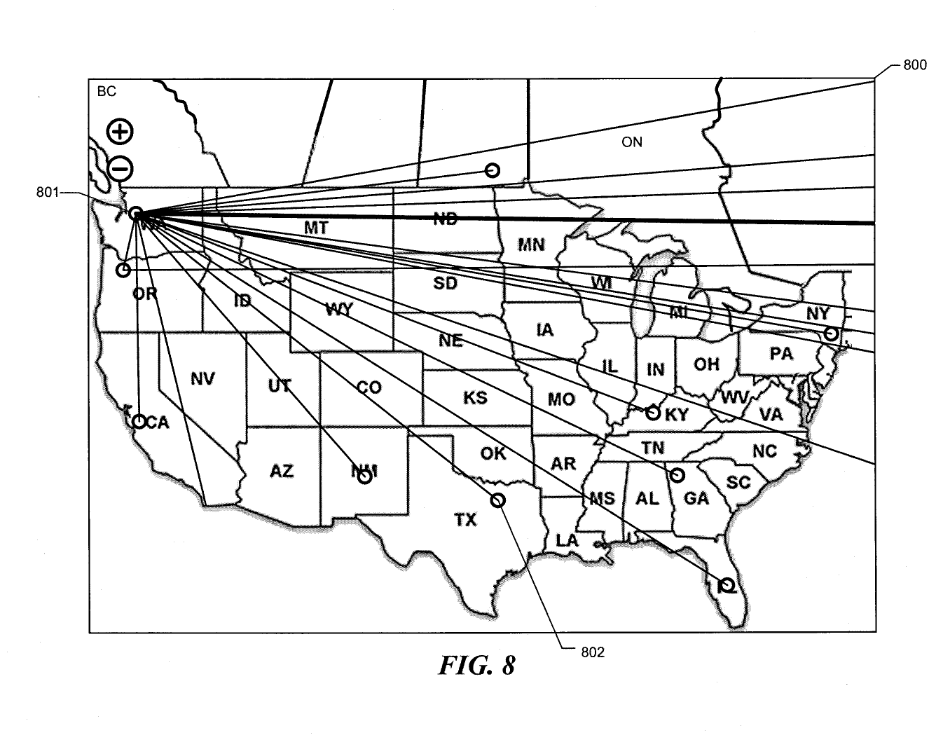

FIG. 8 is a display diagram showing a sample display presented by the facility in some embodiments to illustrate sharing geographically. The display 800 shows a segment between a point 801 in Washington and a point 802 in Texas that indicates that a user in Washington shared the content with a user in Texas. In some embodiments, users can interact with geographic mappings, such as by selecting one of the displayed nodes to display additional information about the corresponding user or that user's sharing behavior.

In some embodiments, the system performs and/or displays the results of trajectory tracking in connection with one or more aspects of the system described in U.S. patent application Ser. No. 11/756,068, filed May 31, 2007, which is hereby incorporated by reference in its entirety.

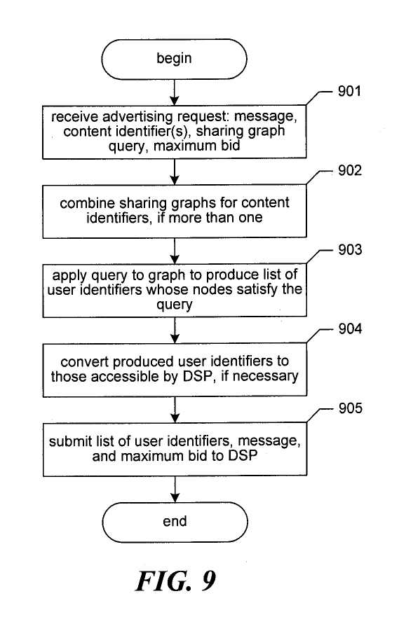

FIG. 9 is a flow diagram showing steps typically performed by the facility in order to present advertising on the basis of content sharing. In step 901, an advertising request is received from a generator of the advertising request who may be, for example, an employee of the advertiser, another representative of the advertiser, and employee of the operator of the facility, etc. In various embodiments, the advertising request includes such information as information specifying or identifying one or more advertising messages to be presented; information identifying content whose sharing is to be the basis of the advertising request; a query against the sharing graph or graphs for the identified content; and a maximum bid for presenting a contact. The specified advertising messages may take a variety of forms, including banner ads, text ads, video ads, slideshow ads, animation ads, etc. The advertising messages may be specified in a variety of ways in advertising request, such as by including the content of the advertising message in the advertising request, or by including advertising request an identifier for the advertising message, a URL for the advertising message, or another reference that can be used to retrieve the content of the advertising message or otherwise present the advertising message. In various embodiments, the content whose sharing is to be the basis of the advertising request can include content at various granularities, including a document, a portion of the web page, a web page, a number of web pages, an entire web site, etc.

In step 902, if more than one piece of content is identified in the advertising request received in step 901, then the facility combines the sharing graphs for these pieces of content into a single sharing graph. In some embodiments, the facility does so by merging nodes of different graphs that refer to the same user, either by containing the same content-independent identifier for that user, or by containing different content-dependent identifiers that identify the same user. In step 903, the facility applies the query included in the received advertising request to the appropriate sharing graph to produce a list of user identifiers whose nodes satisfy the query.

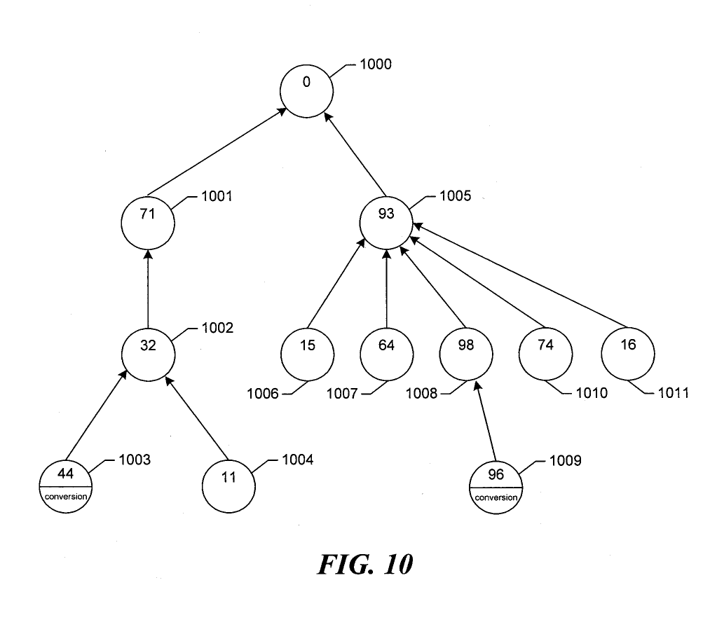

FIG. 10 is a data structure diagram showing a sample content sharing graph that is the subject of sample advertising requests. In the graph, the root node 1000 has child nodes 1001 and 1005. Node 1001 represents the retrieval of the content to which the share graph corresponds by a user having user identifier 71, while node 1005 represents the retrieval of the same content by a user having user identifier 93. Node 1002 is a child node of node 1001, and represents the sharing of the content from the user having user identifier 71 to the user having user identifier 32. Node 1003 is a child node of node 1002, and represents the sharing of the content from the user having user identifier 32 to the user having user identifier 44. Node 1003 further indicates that, subsequent to this sharing, the user having user identifier 44 performed a conversion of that, such as placing an order, registering with a web site, etc.

We now consider the sample graph shown in FIG. 10 with respect to different sample queries. A first sample query identifies any users who share the content with at least three other users. Of the nodes of the graph shown in FIG. 10, only node 1005, representing the user having user node 93, has three or more children, and therefore represents the sharing of the content with at least three other users. Accordingly, a segment produced from this query in connection with the graph shown in FIG. 10 would include only the user having user identifier 93.

A second sample query identifies any user whose sharing of the content resulted either directly or indirectly in at least one conversion event by another user. For this query, the facility identifies all users whose nodes are ancestor nodes of nodes in which conversion occurred, nodes 1003 and 1009 in the sample graph. These ancestor nodes are nodes 1001, 1002, 1005, and 1008. (In the sample graph, root node 1000 does not correspond to an actual user.) Accordingly, the list of users identified for a segment based upon this query is the users having identifiers 32, 71, 93, and 98.

Returning to FIG. 9, in step 904, the facility converts user identifiers in the list produced in step 903 to a list of user identifiers that are accessible in the users' computer systems by the DSP that will be used for the advertising request, if the identifiers presently used in the list are not accessible by that DSP. In some cases, the identifiers used for users in the graph may be those by which the users are known to the DSP. In other cases, however, the identifiers used in the graph may be different from a set by which the users are known to the DSP. In this case, the facility in step 904 uses a mapping from the identifiers used in the graph to the identifiers that are accessible by the DSP. In step 905, the facility submits a fully-qualified advertising request to the DSP, including a list of user identifiers by which the DSP can recognize the users, and the advertising message and maximum bid received in step 901. After step 905, these steps conclude.

When the DSP receives the fully-qualified advertising request, it stores it along with other advertising requests received from customers of the DSP. When a user retrieves a page containing a space for an advertising message—i.e., a “placement”—that is managed by the DSP, an inclusion reference is included in that web page that causes the DSP to be contacted with an identifier by which the DSP recognizes the user retrieving the page. As part of determining what advertising message to cause to appear in the placement, the DSP first identifies advertising messages for which received fully-qualified advertising requests have identified this user as a perspective recipient. Among these advertising messages, the DSP selects one, such as by determining which has the highest bid amount, which is the furthest behind on a committed number impressions, etc. Accordingly, anytime one of the users that is on the list submitted to the DSP in step 905 appears at the DSP with an advertising opportunity, the message specified in step 905 may be presented to the user.

In some embodiments, the facility represents the sharing graph as a flat list of records each corresponding to one of the sharing graph nodes, such as records in a document-oriented database. Table 13 below shows a sample record from the document-oriented database corresponding to node 1009 of the graph shown in FIG. 10.

TABLE 13

| | |
|---|---|
| 1 | user 96 = |

| | | | |
|---|---|---|---|
| 2 | { | materialized path: | [98, 93] |

| | | | |
|---|---|---|---|
| 3 | conversions: | [{ | checkout page, |
| 4 | | | 4/1/2011 2:22:02pm, |
| 5 | | | promotional purchase, |
| 6 | | | $75.00}] |

| | |
|---|---|
| 7 | } |

In line 1, the record contains the user identifier of the user to whom node 1009 corresponds, 96. In line two, the record contains the “materialized path” for node 1009: an ordered list of user identifiers encountered in traversing from node 1009 to the root node, here user identifier 98, followed by user identifier 93. Lines 3-6 contain information about a conversion performed by the user having user identifier 96. Line 3 indicates that the conversion occurred on a checkout page of a merchant web site; line 4 indicates the date and time at which the conversion occurred; line 5 indicates the type of the conversion; and line 6 indicates the amount. If user 96 had performed additional conversions, they would be listed between the close brace and close bracket on line 6.

In order to evaluate the sample queries against the sample graph as represented in the oriented database, the facility proceeds as follows. For the sample query identifying any user who has shared the content with three or more other users, the facility creates and initializes a table for storing a sharing count for each user identifier. The facility then loops through all of the node records, and increments the count for the first user identifier in the materialized path in the record. For the record shown in table 13, the facility increments the count for user identifier 98. After looping through all the records, the facility selects any user identifier having a count at least equal to 3. In some embodiments (not shown), the facility includes additional information in the node record that simplifies evaluation of this query, such as a count of the node's descendants at different depths; in the node record for node 1005, this list of counts would 5 for the depth 1, and 1 for the depth 2, and the count of be 5 for the depth 1 would be compared to the threshold value of 3 and found to be greater than or equal to it, thus qualifying user having user identifier 96 for the segment.

For the sample query that identifies users whose sharing resulted either directly or indirectly in at least one conversion event by another user, the facility loops through each record; determines whether the record notes at least one conversion event; and, if so, adds each user identifier in the materialized path to a list of users in the segment. For example, when visiting the record shown in Table 13, the facility would add user identifiers 93 and 98 to the list of users in the segment.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A method in a computing system for conducting an advertising campaign based upon the sharing of distinguished content, the method comprising:
each time a user seeks to access the distinguished content from a client computer system using a URL associated with the distinguished content:
determining whether a user identifier is represented in the URL;
if a user identifier is represented in the URL that is different from a user identifier that is persistently stored by the client computer system, augmenting a content sharing graph to add a node that indicates that the distinguished content has been shared with a user identified by the user identifier that is persistently stored by the client computer system by a user identified by the identifier represented in the URL;
receiving an advertising request indicating both a test to evaluate against the nodes of the content sharing graph and an advertising message that is to be presented to users represented by nodes of the content sharing graph that satisfy the test;
identifying the nodes of the content sharing graph that satisfy the test; and
transmitting a communication identifying the users represented by the identified nodes as candidates for receiving the indicated advertising message.

2. The method of claim 1 wherein the identifying a node of the content sharing graph depends on information about a second-or-greater-generation descendant of the node.

3. The method of claim 1, wherein the communication further indicates a bid amount for presenting the indicated advertising message to each of the identified users.

4. The method of claim 1, wherein the communication further indicates a number of times that the indicated advertising message is to be presented to users among the identified users.

5. A computer-readable medium whose contents are capable of causing a computing system to perform a method for populating an advertising segment, the method comprising:
for a selected piece of content, accessing a tree in which each non-root node represents a user and each edge between a parent and child pair of non-root nodes represents the sharing of the selected piece of content from the user represented by the parent node to the user represented by the child node;
accessing a segment definition specifying a test that, for each non-root node, is either satisfied for the node based on an analysis of the node's subtree or not satisfied for the node based on an analysis of the node's subtree;
identifying the non-root nodes for which the test is satisfied; and
constructing a list of identifiers identifying the users represented by the identified nodes.

6. The computer-readable medium of claim 5 wherein the accessed tree represents the sharing of a widget.

7. The computer-readable medium of claim 5 wherein the accessed tree represents the sharing of a portion of a web page.

8. The computer-readable medium of claim 5 wherein the accessed tree represents the sharing of a web page.

9. The computer-readable medium of claim 5 wherein the accessed tree represents the sharing of a group of web pages.

10. The computer-readable medium of claim 5 wherein the accessed tree represents the sharing of a web site.

11. The computer-readable medium of claim 5 wherein the tree is accessed in a document-oriented database representation.

12. The computer-readable medium of claim 5 wherein the method further comprises:
detecting instances in each of which the selected content is shared from a sharing source user to a sharing target user;
constructing the accessed tree by:
initializing the tree; and
for each detected instance of sharing, adding to the tree as a child of a node representing the sharing source user a node representing the sharing target user.

13. The computer-readable medium of claim 12 wherein at least one of the instances of sharing for which a node is added to the tree is an implicit instance of sharing first detectable from a request by sharing target user to retrieve the selected piece of content.

14. The computer-readable medium of claim 12 wherein at least one of the instances of sharing for which a node is added to the tree is an instance of sharing in which a reference to the selected piece of content is communicated from the sharing source user to the sharing target user via a channel not monitored as part of the detecting.

15. The computer-readable medium of claim 12 wherein at least one of the instances of sharing for which a node is added to the tree is an instance of sharing in which a reference to the selected piece of content is communicated from the sharing source user to the sharing target user via email.

16. The computer-readable medium of claim 12 wherein at least one of the instances of sharing for which a node is added to the tree is an instance of sharing in which a reference to the selected piece of content is communicated from the sharing source user to the sharing target user via instant message.

17. The computer-readable medium of claim 12 wherein at least one of the detected instances of sharing is to a sharing target user using a mobile device.

18. The computer-readable medium of claim 5 wherein the identifying involves analyzing each node's subtree to a depth of at least two.

19. The computer-readable medium of claim 5 wherein the method further comprises conducting an advertising campaign using the constructed list of identifiers.

20. The computer-readable medium of claim 5 wherein the method further comprises transmitting the constructed list of identifiers to a computer system that selects advertising messages to be presented to users including users among the users identified by the identifiers of the list.

21. The computer-readable medium of claim 20 wherein the method further comprises transmitting to the computer system that selects advertising messages to be presented to users including users among the users identified by the identifiers of the list an indication of an advertising message that is to be presented to users among the users identified by the identifiers of the list.

22. A method for populating an advertising segment, comprising:
for distinguished content, accessing a data structure that, for each of a plurality of users, relates an instance of sharing the distinguished content to the user with one or more instances of sharing the distinguished content from the user;
accessing a segment definition specifying a test that, for each of the plurality of users, is either satisfied or not satisfied based upon the contents of the data structure;
identifying the users for whom the test is satisfied; and
constructing a list of identifiers identifying the identified users.

23. The method of claim 22, further comprising:
detecting a plurality of instances of sharing the distinguished content, each by:
receiving an HTTP request for a distinguished URL associated with the distinguished content;
in response to receiving the HTTP request, retrieving a user identifier associated with the distinguished URL;
if the received HTTP request contains a copy of the retrieved user identifier, responding to the received HTTP request by serving a page containing at least a portion of the distinguished content;
if the received HTTP request does not contain a copy of the retrieved user identifier:
generating a new URL associated with the distinguished content;
storing the new URL together with a user identifier for the user originating the received HTTP request and an indication that the user having the user identifier associated with the distinguished URL shared the distinguished content with the user originating the received HTTP request; and
responding to the received HTTP request with a redirect to the new URL.

24. The method of claim 22 where in the identifying involves, for each of at least a portion of the plurality of users, analyzing how the distinguished content was shared by users to whom the user shared the distinguished content.

25. One or more computer memories collectively storing an advertising segment definition data structure, comprising:
information specifying a test that can be performed against at least a portion of the nodes in a content sharing graph in which each node represents the user, and each edge from a source node to a destination node represents the sharing of the same piece of content from the user represented by the source node to the user represented by the destination node,
such that the path specified by the information contained by the data structure can be applied to each node of a content sharing graph in order to identify a set of users who belong to an advertising segment defined by the advertising segment definition data structure.

26. The computer memories of claim 25, wherein the test specified by the data structure is expressed in terms of a document-oriented database representing the sharing graph.

27. A computer-readable medium storing an advertising segment data structure for an advertising segment, comprising:
a plurality of identifiers each identifying a person who is a member of the advertising segment, each of the plurality of identifiers having been added to the advertising segment definition data structure based on determining that a test about how the selected piece of content was shared by users to whom the identified user shared the selected piece of content is satisfied,
such that the advertising segment data structure can be provided for use in directing an advertising campaign to the identified people.
